(19) United States
(12) Patent Application Publication
(10) Pub. No.: US 2012/0041740 A1
(43) Pub. Date: Feb. 16, 2012

(54) DIGITISATION OF DENTAL PARTS

(75) Inventors: David BEEBY, Wotton-under-Edge (GB); Iain AINSWORTH, Henleaze (GB); Ram Kumar REVANUR, Pune (IN); Geoffrey David RAYNER, Dursley (GB)

(73) Assignee: RENISHAW PLC, WOTTON-UNDER-EDGE (GB)

(21) Appl. No.: 13/206,998

(22) Filed: Aug. 10, 2011

Related U.S. Application Data
(60) Provisional application No. 61/372,547, filed on Aug. 11, 2010.

(51) Int. Cl. G06G 7/60; G06F 17/50

(52) U.S. Cl. 703/11

(57) ABSTRACT

The surface of a dental part is scanned by a probe, to obtain a digital model of the surface in a dental CAD computer system. In the digital model, first and second boundary lines are defined, above and below a portion in which the scanned data is missing or unsatisfactory. One of the boundary lines may correspond to a margin line between prepared and unprepared portions of the patient's tooth. A transition surface is generated in the computer system, extending between the first and second boundary lines. This improves the representation of the dental part in the digital model, which may subsequently be used for manufacture of a dental restoration.

### FIELD OF THE INVENTION

This invention relates to dental CAD methods and systems. It is particularly useful in the scanning of dental parts e.g. for the manufacture of dental restorations (such as crowns, bridges and abutments) and dental copings.

### DESCRIPTION OF PRIOR ART

Referring to FIG. 1, a typical known dental restoration process proceeds as follows. The dentist prepares a patient's tooth by removal of material, leaving a preparation to which he can subsequently affix a restoration (which may for example take the form of a crown, bridge or abutment). An impression is made of the tooth preparation, from which a model of it is formed. The model is scanned by a scanning machine 10 in order to digitise the surface of the preparation. This gives data for a computer aided design (CAD) model, defining an interior surface of the restoration. A dental technician then builds a wax-up model of the intended restoration onto the model of the preparation. This is again scanned by the scanning machine 10, in order to digitise the surface as further data for the CAD model. This is used to define the exterior surface of the restoration.

A computer CAD/CAM system 12 controls the scanning processes and manipulates the CAD data. It then sends instructions to a manufacturing system, such as a milling machine 14 or other machine tool, in order to manufacture the restoration, e.g. by milling from a blank of ceramic material. Alternatively, the CAD/CAM system 12 sends instructions to the milling machine for the manufacture of a coping, onto which the dental technician may add a layer of a cosmetically-acceptable finishing material such as porcelain. Finally, the dentist fits the restoration to the tooth preparation in the patient's mouth.

FIG. 2 illustrates a problem which occurs, and the way in which it is solved in a known CAD/CAM system. It shows a model 16 of the tooth preparation, and the wax-up model 18 built up onto it by the technician. A stylus 20 of a scanning probe in the scanning machine 10 has a spherical tip 22 which contacts the model as the scan proceeds. Unfortunately, the tip 22 cannot access undercut regions of the wax-up model, such as shown at 24, because the stylus 20 fouls against the surface of the wax-up 18. The result is that the CAD model of the wax-up 18 includes unsatisfactory data, in the form of a phantom vertical surface 26 around the undercut region 24.

A similar problem can arise if the model is scanned using a non-contact probe such as an optical probe, rather than with a contact probe as shown in FIG. 2. If there is a region where an optical probe has no direct line of sight to the surface of the model 18, then the CAD model has missing or unsatisfactory data for that region. Variations in surface reflectance may also cause data produced by an optical probe to be unsatisfactory or missing. With both contact and optical probes, the problem is not restricted to wax-up models, and can arise when scanning any type of dental model. It can also arise when performing an intra-oral scan of a prepared tooth, directly in the patient's mouth.

The known CAD/CAM system includes a software routine which defines a margin line 28 in the CAD model. This is a digitally sketched contour around the CAD model, which corresponds to the margin between the prepared and unprepared portions of the patient's tooth. Its purpose is to define the transition between the finished restoration and the patient's tooth. To solve the above problem, the known CAD/CAM system also uses this margin line to define the lower, interior edge of a swept 45° surface 30 around the undercut region 24 of the wax-up. As seen in FIG. 2, the 45° surface 30 insects with the phantom vertical surface 26. In the CAD model, the undercut region 24 is then approximated by these two intersecting surfaces.

Of course, this does not give a completely accurate representation of the wax-up model. It may be necessary to remove surplus material, either virtually by manually editing the CAD model within the CAD/CAM system, or by physically removing material after the restoration or coping has been manufactured.

### SUMMARY OF THE INVENTION

One aspect of the present invention provides a method for scanning a dental part, comprising:
scanning a surface of the dental part to obtain a digital model of the surface in a computer system, the digital model having missing or unsatisfactory data corresponding to a portion of the surface;
in the computer system, defining a first boundary line on the scanned surface of the dental part, below said portion;
in the computer system, defining a further boundary line on the scanned surface of the dental part, above said portion;
in the computer system, generating a transition surface extending between the first boundary line and the further boundary line.

A second aspect of the present invention provides a method of processing a digital model of the surface of a dental part in a computer system, the digital model having missing or unsatisfactory data corresponding to a portion of the surface, the method comprising:
in the computer system, defining a first boundary line on the scanned surface of the dental part, below said portion;
in the computer system, defining a further boundary line on the scanned surface of the dental part, above said portion;
in the computer system, generating a transition surface extending between the first boundary line and the further boundary line.

Further aspects of the invention provide a dental CAD system configured to operate in accordance with any of the above methods; and a computer program stored in a machine readable medium which when loaded into a dental CAD system configures it to so operate.

References to missing or unsatisfactory data in the digital model include any portion of the digital model which does not correspond to the desired shape of the dental part which is to be manufactured from it.

### BRIEF DESCRIPTION OF THE DRAWINGS

FIG. 1 is a schematic block diagram of a known system for scanning and manufacturing dental parts;

FIG. 2 illustrates a prior method for scanning a dental part;

FIG. 3 illustrates a method according to the invention for scanning a dental part;

FIG. 4 is a flowchart of the method shown in FIG. 3, operated by a program in a CAD/CAM computer system;

FIGS. 5 and 6 illustrate a method for selecting points for use in the method of FIGS. 3 and 4; and

FIG. 7 illustrates a modification of the method of FIG. 3.

### DESCRIPTION OF PREFERRED EMBODIMENTS

Embodiments of the invention will now be described, purely by way of example, with reference to the accompanying drawings.

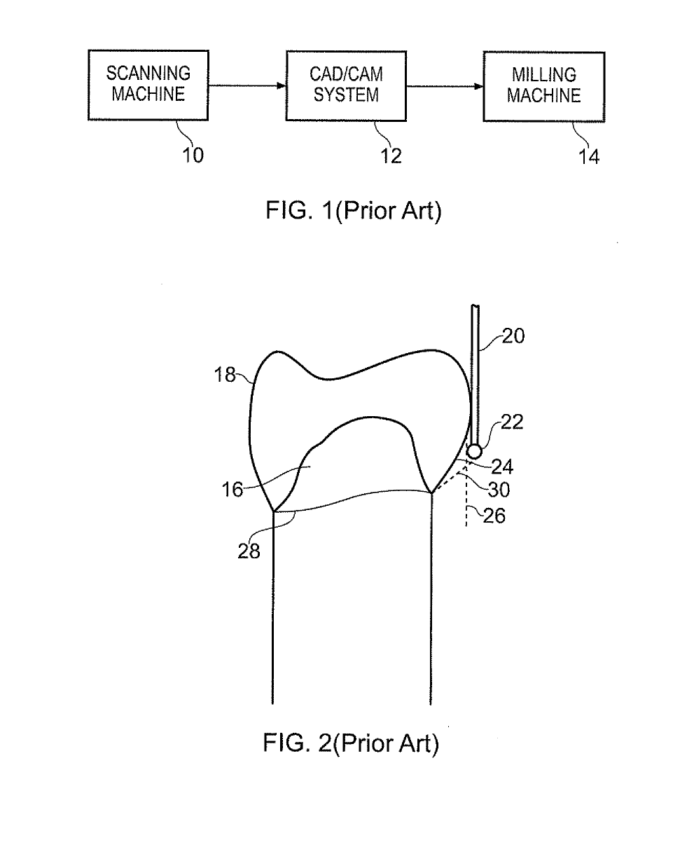

The embodiments described are provided by computer programs operating within a dental CAD system, such as the CAD/CAM system 12 shown in FIG. 1. Thus, an initial dental part is scanned on a scanning machine 10. The data is manipulated in the CAD system as discussed below. Subsequently, instructions are sent to a milling machine tool 14, in order to manufacture a resulting dental part, e.g. by milling from a ceramic material. The resulting dental part may be a dental restoration (such as a crown, bridge or abutment) or a coping for a restoration.

Of course, the scanning machine, the CAD system and the machine tool need not be located together, since data can be sent between them e.g. on a disc, a memory stick or card or over a communications network such as the Internet. The scanning machine could use a contact scanning probe, as in FIG. 2, or it could be a laser or other optical scanner. It could be an intra-oral probe (e.g. an optical probe) used to scan a tooth preparation directly in the patient's mouth. Other machine tools instead of milling machines are possible, including both traditional types of machine tool and additive or layer manufacturing systems e.g. using laser sintering or wax printing.

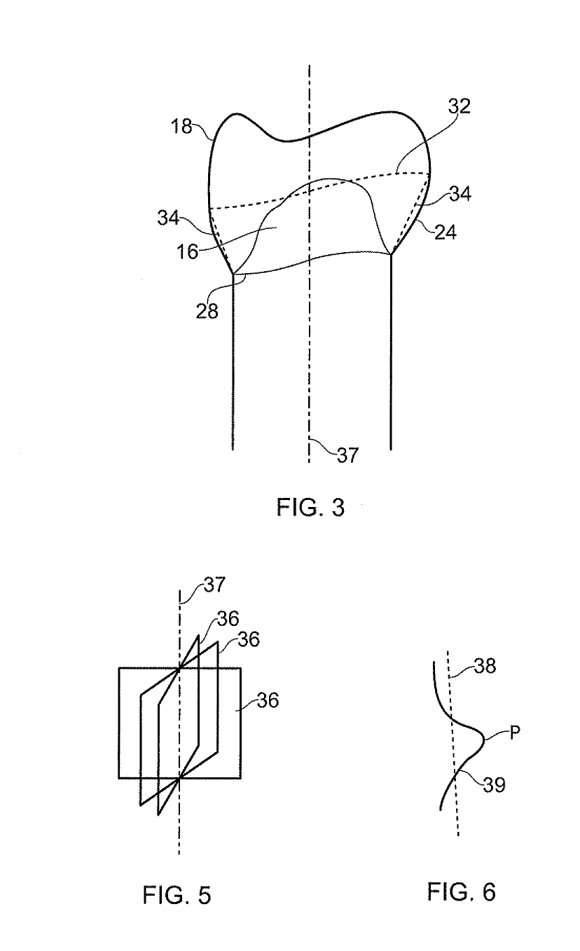

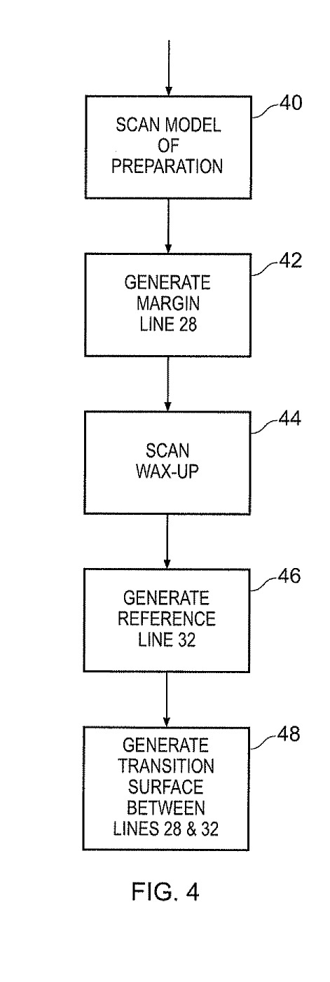

FIGS. 3 and 4 show a model 16 of a dental preparation as an example. In a step 40 the program in the CAD/CAM system 12 first scans the model 16, producing digitised data forming a CAD model of the preparation. This defines the internal surface of a restoration or coping which is to be fitted to the preparation. The system 12 includes a software routine (step 42) which generates a margin line 28 as part of the CAD model, in a conventional way. This is a first boundary line which contours around the model, corresponding to the margin between the prepared and unprepared portions of the patient's tooth. Its primary purpose is to define the transition between the finished restoration and the patient's tooth, as in the prior art discussed above.

Next, a dental technician builds a wax-up model 18 of the intended restoration onto the model 16 of the preparation. In step 44, this too is then scanned by the scanning machine 10, producing further digitised data describing its surface. However, as explained above in relation to FIG. 2, some or all parts of the undercut portions 24 of the wax-up 18 may not be accessible to the probe of the scanning machine and so may not be accurately represented in this digital data. Thus, the digital model produced includes unsatisfactory data. Or the technician may choose simply not to scan the undercut portions, so that data corresponding to them is missing.

The digitised surface data produced in step 44 from the wax-up forms a reference surface for use in the rest of the procedure. It may represent the intended exterior surface of the restoration to be produced. Alternatively, it may represent the intended exterior surface of a coping, onto which the dental technician will subsequently apply a layer of porcelain.

The data representing the reference surface may be produced in other ways, without building and scanning a wax-up. It can be produced by scanning from another model, e.g. a stone model or one made from plaster or a plastic resin. It can be generated by the computer program from a predefined CAD model of an artefact or tooth, or generated on-the-fly on the basis of appropriate parameters. Or it can be imported from a CAD library. In these cases, the imported reference surface may already have undercut portions defined. However, these will not be tailored to the specific margin line of the preparation 16, so they will still be inaccurate, and therefore unsatisfactory.

A further alternative is that the reference surface may be sketched digitally by the dental technician, overlying the model of the preparation 16 on a computer screen of the CAD/CAM system 11 Or it may be generated by morphing or otherwise modifying the data of the surface of the preparation 16.

However it is generated, the program in the CAD/CAM system 12 combines this reference surface data into the CAD model, forming the exterior surface of the restoration or coping.

In step 46, the program defines a further reference boundary line 32 in the CAD model. This is a line which contours around the reference surface, above the regions where the data is missing or unsatisfactory, such as the undercut portions 24 (or at least, above those parts of the undercut portions which it has not been possible to access with the tip 32 of the probe stylus 20 as shown in FIG. 2).

The reference boundary line 32 can be generated in various different ways.

For example, it can be generated in the same way as the margin line 28. The program may allow the technician to click with a computer mouse (or another pointer device) to indicate various points around the CAD model, as represented on the screen of the computer system 12. The program then generates a line connecting the points indicated.

FIGS. 5 and 6 illustrate one possible method which is known for generating a margin line 28 from such points indicated by a mouse or other pointer device, e.g. using the scanned data representing the surface of the preparation 16. In the embodiments of the present invention, it may also be used to generate the reference boundary line 32 from the data representing the reference surface 18.

FIG. 5 illustrates a plurality of vertical planes 36, spaced at equal angles about a vertical axis 37 of the digital CAD model. These may be defined as virtual planes within the CAD/CAM system 12; they need not be displayed on the screen of the computer system. Only a few planes are illustrated, but in practice there may be, for example, thirty planes spaced around the vertical axis. When the technician clicks with the mouse on the representation of the CAD model shown on the screen of a computer system 12, the program selects the nearest of these virtual vertical planes.

FIG. 6 is a view in the vertical plane 36 thus selected, including the profile 39 of the surface of the digital CAD model within that plane. The program next defines a line 38 which extends within this vertical plane 36 (or a plane 38 which is normal to it). This line or plane 38 is chosen such that it passes within a predetermined distance from the point indicated by the technician using the mouse. Using standard mathematical techniques, the program then determines the point P on the profile 39 which is the maximum distance from the line or plane 38. This is taken as a selected point on the margin line 28 or reference boundary line 32, as the case may be.

Alternatively, if the line or plane 38 is defined to lie outside the profile 39 (i.e. to the right of it as shown in FIG. 6) then the program may determine the point P as the point on the profile 39 which is a minimum distance from the line or plane 38, rather than the maximum distance.

The line or plane 38 may not itself be vertical. Suitably it extends at an angle to the vertical, chosen to ensure that the point P selected is appropriate for the margin line 28 or reference line 32.

The program therefore intelligently selects suitable points P for forming the margin line or reference line within some or all of the vertical planes 36, close to the points actually clicked with the mouse by the technician. Finally, the computer program generates the margin line 28 or reference line 32 by connecting the points P thus determined, rather than the points actually clicked by the technician. Or rather than connecting the points P directly, they may be used as control points in a 3D spline algorithm which generates the line.

Alternatively, the reference boundary line 32 can be generated as a contour on the reference surface which is a predefined distance above the margin line 28. Or other automatic heuristics may be used, for either or both of the margin line 28 and the reference line 32. E.g. they may be generated using appropriately selected parameters generated from the CAD representation of the surfaces.

However the reference boundary line 32 is generated, the program in the CAD/CAM system 12 then offers the technician the opportunity to modify it. Conveniently this can be done on the computer screen, by dragging or morphing portions of the line with a mouse or other pointer device. The resulting boundary line is saved as part of the CAD model.

It has been described that the missing or unsatisfactory data corresponds to the undercut portions 24. However, the invention is also applicable to missing or unsatisfactory data resulting from other problems, such as an optical shadow (the lack of a line of sight) or variations in surface reflectance when scanning with an optical probe. It is also applicable if there is missing or unsatisfactory data corresponding to a physical hole or other defect in the tooth or model or impression being scanned.

It should be understood that for the first boundary line 28, the invention is not restricted to the use of a line which corresponds to the margin between the prepared and unprepared portions of the patient's tooth. It is possible to generate an arbitrary first boundary line at any suitable location below the missing or unsatisfactory data, for example in any of the ways described for generating the further boundary line 32.

In step 48 (FIG. 4), the program in the CAD/CAM system 12 generates a transition surface 34 between the margin line 28 and the reference boundary line 32, and saves it as part of the CAD model. Conveniently this may simply be a swept straight line generating a straight-ruled surface between the lines 28 and 32. However, a swept curved line may be used instead, for example to more closely approximate the typical convex shape of the undercut portion 24 as seen in FIG. 3, e.g. to match the patient's gingiva. The curved shape of the swept line may be changed as it sweeps around the model. For example, the computer system 12 may generate the curved shape in such a manner that a smooth transition is maintained with the good scanned data above the boundary line 32, at all points around the model. To achieve this, the curved shape may be generated as a spline, e.g. a non-uniform rational B-spline (NURBS). Once again, the program may give the technician the opportunity to adjust or modify the generated surface on the computer screen.

Finally, the CAD/CAM system 12 may generate instructions from the resulting CAD model, which when passed to the milling machine 14 (FIG. 1), or another type of machine tool as discussed above, will produce the desired restoration or coping or other dental part.

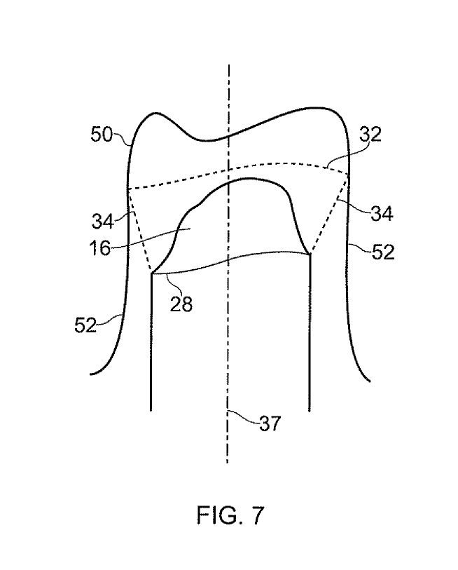

FIG. 7 illustrates a modification to FIG. 3. Instead of the FIG. 3 wax-up 18 with undercut portions 24, the technician may build a wax-up 50. The upper portions of this conform to the desired shape and contours of the finished restoration or coping. But as shown in FIG. 7, no care is taken to ensure that the lower portions 52 of the wax-up 50 match the intended lower surfaces of the resulting restoration or coping. As with the phantom surface 26 in FIG. 2, therefore, scanned data from the lower portions 52 is unsatisfactory, or may simply missing if the technician chooses not to scan these lower portions.

Nevertheless, in the FIG. 7 example, a reference boundary line 32 is formed in one of the same ways as described above. A transition surface 34 is then generated in the same manner as above, between the margin line 28 and the reference line 32. This removes the bad data for the portions 52 from the CAD model.

It will be appreciated that the CAD model resulting from the above method and system more accurately represents the portions with unsatisfactory or missing data than in the prior art method shown in FIG. 2. There is less need for subsequent adjustment of the model or removal of material from the manufactured restoration or coping. There are significant benefits of convenience and time-saving.

1. A method for scanning a dental part, comprising:
scanning a surface of the dental part to obtain a digital model of the surface in a computer system, the digital model having missing or unsatisfactory data corresponding to a portion of the surface;
in the computer system, defining a first boundary line on the scanned surface of the dental part, below said portion;
in the computer system, defining a further boundary line on the scanned surface of the dental part, above said portion;
in the computer system, generating a transition surface extending between the first boundary line and the further boundary line.

2. A method according to claim 1, wherein the portion to which the missing or unsatisfactory data corresponds is an undercut portion of the dental part.

3. A method according to claim 1, wherein the first boundary line is a margin line representing the boundary between prepared and unprepared portions of a tooth.

4. A method according to claim 3, wherein the digital model represents a dental restoration or coping, and the margin line is derived from an internal surface thereof.

5. A method according to claim 1, wherein the digital model represents a dental restoration or coping, and the further boundary line is derived from an exterior surface thereof.

6. A method according to claim 1, wherein at least a part of the digital model is produced by scanning a wax-up model of a dental restoration or coping.

7. A method according to claim 1, wherein the digital model represents a gingival surface, and transition surface which is generated represents a part of an abutment for a dental implant.

8. A method according to claim 1, wherein the transition surface is generated by sweeping a line around the digital model, between the first boundary line and the further boundary line.

9. A method of processing a digital model of the surface of a dental part in a computer system, the digital model having missing or unsatisfactory data corresponding to a portion of the surface, the method comprising:
in the computer system, defining a first boundary line on the scanned surface of the dental part, below said portion;
in the computer system, defining a further boundary line on the scanned surface of the dental part, above said portion;
in the computer system, generating a transition surface extending between the first boundary line and the further boundary line.

10. A method according to claim 9, wherein the portion to which the missing or unsatisfactory data corresponds is an undercut portion of the dental part.

11. A method according to claim 9, wherein the first boundary line is a margin line representing the boundary between prepared and unprepared portions of a tooth.

12. A method according to claim 11, wherein the digital model represents a dental restoration or coping, and the margin line is derived from an internal surface thereof.

13. A method according to claim 9, wherein the digital model represents a dental restoration or coping, and the further boundary line is derived from an exterior surface thereof.

14. A method according to claim 9, wherein the digital model represents a gingival surface, and transition surface which is generated represents a part of an abutment for a dental implant.

15. A method according to claim 9, wherein the transition surface is generated by sweeping a line around the digital model, between the first boundary line and the further boundary line.

16. A dental CAD system configured to operate in accordance with a method according to claim 1.

17. A computer program stored in a machine readable medium which when loaded into a dental CAD system configures it to operate in accordance with a method according to claim 1.

18. A dental CAD system configured to operate in accordance with a method according to claim 9.

19. A computer program stored in a machine readable medium which when loaded into a dental CAD system configures it to operate in accordance with a method according to claim 9.
